(19) United States
(12) Patent Application Publication
(10) Pub. No.: US 2007/0032395 A1
(43) Pub. Date: Feb. 8, 2007

(54) Aqueous liquid detergent compositions comprising anionic esters of alkylpolyglycosides and enzymes

(76) Inventors: Darlo Fornara, Novara (IT); Tamara Verzotti, Bellinzago (IT); Tullio Pellizzon, Paderno Dugnano (IT); Piera Pericu, Milano (IT); Yves Galante, Arese (IT); Giuseppe Li Bassi, Gavirate (IT)

Correspondence Address: PAUL S MADAN;MADAN, MOSSMAN & SRIRAM, PC, 2603 AUGUSTA, SUITE 700, HOUSTON, TX, 77057-1130, US

(21) Appl. No.: 10/560,145

(22) PCT Filed: Jun. 1, 2004
(86) PCT No.: PCT/EP04/50966

§ 371 Date: Dec. 9, 2005

(30) Foreign Application Priority Data
Jun. 13, 2003 (IT) VA2003A000019

(51) Int. Cl. C11D 3/20

(52) U.S. Cl. 510/235; 510/470

(57) ABSTRACT

The present invention is related to aqueous liquid detergent compositions comprising anionic esters of alkylpolygly-cosides and enzymes, and to the procedure for their preparation; the aqueous liquid detergent compositions of the invention exhibit long term enzymatic stability and excellent washing performance.

### TECHNICAL FIELD

This invention is related to aqueous liquid detergent compositions comprising anionic esters of alkylpolyglycosides and enzymes, and to the procedure for their preparation.

The aqueous liquid detergent compositions of the invention exhibit long term enzymatic stability and excellent washing performance.

### BACKGROUND ART

It is well known that washing performance of detergents is mainly due to their surfactant composition.

In the majority of cases, such surfactant composition is made of mixtures of anionic, non-ionic, and, in some case, of amphoteric surfactants.

The best washing performance is usually obtained by using a combination of anionic and non-ionic surfactants.

In recent years, detergent compositions in powder form with improved washing performance by the presence of one or more enzymes have increased their market share.

The preparation and use of powder detergent formulations comprising enzymes, in addition to the usual problems related to dusting, may lead to sensitisation in selected Individuals if inhaled.

On the other hand, the incorporation of one or more enzymes in aqueous liquid detergent compositions can represent considerable technical problems due to the fact that enzymes can be rapidly inactivated in an aqueous environment in the presence of anionic surfactants, which are a fundamental component of detergents.

Such problems of compatibility between enzymes and surfactants occur to a less extent with non ionic surfactants, as their Inactivation effect on enzymes is lower.

The inactivation of enzymes in liquid aqueous detergent formulations has been investigated and described in the literature, for example in KRAVETZ, L., et al. Effect of surfactant structure on stability of enzymes formulated into laundry liquids. Journal of the American Oil Chemists' society. 1985, vol.62, no.5, p.943-949. and in RUSSEL, Gooffry L, et al. Use of certain alcohol ethoxylates to maintain protease stability in the presence of anionic surfactants. Journal of surfactants and detergents. 2002, vol.5, no.1, p.5-10.

In the known techniques the use of stabilisers or of mixtures of stabilisers is suggested in order to improve the stability of enzymes in aqueous liquid detergent compositions.

As an example, we cite the stabilisers or mixtures of stabilisers described in U.S. Pat. No. 4,305,837, U.S. Pat. No. 4,318,818, U.S. Pat. No. 4,637,707, U.S. Pat. No. 4,670,179, U.S. Pat. No. 4,949,179, U.S. Pat. No. 5,071,586, U.S. Pat. No. 5,156,773, U.S. Pat. No. 6,121,225; however, these stabilisers only prevent or delay the inactivation of enzymes, without contributing in any way to the overall washing performance of the detergent mix.

Another possibility is to improve the stability of enzymes in aqueous detergent compositions by modifying the surfactant compositions.

This can be obtained, for example, by increasing the amount of non-ionic surfactants and at the same time by reducing the amount of anionic surfactant, as described in WO 9845396.

It is nevertheless still highly desirable to provide anionic surfactants, which, when incorporated in aqueous liquid detergents, could exhibit little inactivating effect on enzymes, or at least surfactants which exhibit a inactivating effect smaller then the one of traditional anionic surfactants.

It is further desirable to provide anionic surfactants that, when incorporated in aqueous liquid detergents, can contribute to the washing performance of said mixtures at least as much as the traditional anionic surfactants.

### DISCLOSURE OF INVENTION

It has now surprisingly been found that, in aqueous liquid detergent compositions, anionic esters of alkylpolyglycosides exhibit a low inactivating effect on enzymes, in comparison with the normally used anionic surfactants.

The anionic esters of alkylpolyglycosides, which are described for example in EP 510,564 and in EP 510,565, show in aqueous liquid detergent compositions, comprising them together with an enzyme, a better stability and washing performance then the traditional anionic surfactants.

It is therefore an object of the presence invention an aqueous liquid detergent composition showing high enzymatic stability and washing performance and comprising:

a. from 0.1 to 70% by weight (wt %), preferably from 10 to 30 wt %, of one or more anionic surfactant selected among anionic ester of alkylpolyglycosides having general formula:
[R—O-(G)ₓ]ₙ-(D)_{y} (I)

wherein:

R is an aliphatic group, saturated or unsaturated, linear or branched, having from 6 to 20 atoms of carbon, preferably from 8 to 16 atoms of carbon;

G is a residue of a reducing saccharide, preferably of glucose, connected to R—O by means of an ethereal O-glycosidic bond;

O is an oxygen atom;

D is an acyl residue of sulfosuccinic acid or of a carboxylic acid selected from the group consisting of citric, tartaric, maleic and malic acid, connected to an oxygen atom of G;

n is a number between 1 and m−1, where m is the number of carboxylic groups in the acid that originates D;

x is a number from 1 to 10, representing the average degree of oligomerization of G;

y is a number from 1 to 10 representing the degree of average esterification of (G)ₓ.

b. from 0.05 to 10 wt %, preferably from 0.10 to 5 wt %, of an enzyme selected in the group consisting of proteases, amylases, lipases, cellulases and mixture thereof,

c. from 10 to 95 wt %, preferably from 20 to 70 wt %, of water.

The preferred anionic esters of alkylpolyglycosides useful for the realisation of the present invention are: alkylpolyglucoside citrate disodium salt, alkylpolyglucoside sulfosuccinate disodium salt and alkylpolyglucoside tartrate sodium salt, which are respectively available on the market under the trade names Eucarol® AGE EC, Eucarol® AGE SS, Eucarol® AGE ET (Cesalpinia Chemicals, Italy).

In addition to the above described essential constituents, the aqueous liquid detergent compositions of the invention may contain from 0.1 to 50 wt %, preferably from 10 to 30 wt %, of one or more anionic surfactants having general formula different from (I), in amount not exceeding the amount of the surfactants having general formula (I).

In particular, the anionic surfactants having general formula different from (I) are chosen among linear or branched C₉-C₁₅ alkylsulfate, linear or branched C₉-C₁₅ alkylbenzenesulfonates, C₈-C₂₄ polyethoxylated alkyl ether sulfates containing from 1 to 20 ethoxylic groups.

The aqueous liquid detergent compositions of the invention may further contain non-ionic surfactants, such as: C₈-C₁₈ ethoxylated and/or propoxylated fatty alcohols containing from 1 to 20 ethoxyl or propoxyl groups and C₈-C₁₈ ethoxylated and/or propoxylated alkylphenols containing from 1 to 20 ethoxyl or propoxyl groups.

The aqueous liquid detergent compositions of the invention may further contain cationic and amphoteric surfactants.

It is a further fundamental object of the present invention a procedure for the preparation of aqueous liquid detergent compositions having high enzymatic stability comprising the following steps (wt % are referred to the final composition):

A. from 0.1 to 70 wt %, preferably from 10 to 30 wt %, of one or more anionic surfactants selected among anionic ester of alkylpolyglycosides having general formula:
[R—O-(G)ₓ]ₙ-(D)_{y} (I)

wherein:

R is an aliphatic group, saturated or unsaturated, linear or branched, having from 6 to 20 atoms of carbon, preferably from 8 to 16 atoms of carbon;

G is a residue of a reducing saccharide, preferably of glucose, connected to R—O by means of an ethereal O-glycosidic bond;

O is an oxygen atom;

D is an acyl residue of sulfosuccinic acid or of a carboxylic acid selected from the group consisting of citric, tartaric, maleic and malic acid, connected to an oxygen atom of G;

n is a number between 1 and m−1, where m is the number of carboxylic groups in the acid that originates D;

x is a number from 1 to 10, representing the average degree of oligomerization of G;

y is a number from 1 to 10 representing the degree of average esterification of (G),

are mixed with from 10 to 95 wt %, preferably from 20 to 70 wt %, of water, under stirring;

B. the mixture is stirred for 10-30 minutes at a temperature of 15-30° C., and the pH is adjusted to 4-8;

C. from 0.05 to 10 wt % of an enzyme selected in the group consisting of proteases, amylases, lipases, cellulases and mixture thereof is added while stirring.

According to a preferred aspect of the invention, after step A., from 0.1 to 50 wt %, preferably from 10 to 30 wt %, of one or more anionic surfactants having general formula different from (I) are added while stirring to the obtained mixture, said anionic surfactants being added in an amount not exceeding the amount of the surfactant having general formula (I); preferably the anionic surfactants having general formula different from (I) are chosen among linear or branched C₉-C₁₅ alkylsulfate, linear or branched C₉-C₁₅ alkylbenzenesulfonates, C₈-C₂₄ polyethoxylated alkyl ether sulfates containing from 1 to 20 ethoxylic groups.

The enzymes useful for the realisation of the invention are the enzymes commercially available and normally used in detergent compositions.

Among those, proteases are the preferred ones, and alkaline proteases are the most preferred ones.

As commercial sources of enzymatic preparations comprising alkaline proteases, we cite by way of example, but not to be limited, the products sold by Genencor under the trade name Purafect® and the products sold by Novozymes under the trade name Savinase®, Durazyme® and Esperase®.

Other additives which are normally present in aqueous liquid detergents may be contained in the aqueous liquid detergent compositions of the invention; by way of example we cite: optical brighteners, softeners, anti-foams, foaming agents, perfumes, dyes, stabilisers, suspending agents, biocides, pH regulators, sequestering agents.

The aqueous liquid detergent compositions of the invention may be used in household cleaning (on various surfaces, stoves, floors, glasses, sanitary wares) and for the washing of laundry, but they can also be used as heavy duty cleaning liquid detergents (HDLD).

The following examples illustrate the Improved enzymatic stability and the good washing performance of the aqueous liquid detergent compositions of the invention; they are not intended to unduly limit the invention Itself.

In the examples the following anionic esters of alkylpolyglycosides have been used, all sold by Cesalpinia Chemicals SpA:

Eucarol® AGE EC=alkylpolyglucoside citrate disodium salt, 30 wt % active substance (a.s.);

Eucarol® AGE ET=alkylpolyglucoside tartrate sodium salt, 30 wt % a.s.;

Eucarol® AGE SS=alkylpolyglucoside sulfosuccinate disodium salt, 45% a.s.;

The following traditional anionic surfactants have also been used, all commercialised by Cesalpinia Chemicals SpA:

Chimpon BAC=sodium dodecylbenzenesulfonate, 50 wt % a.s.;

Rolpon 24/230=sodium laurylether(2)sulfate, 27 wt % a.s.;

Rolpon LS=sodium laurylsulfate, 28 wt % a.s.

The following methods of evaluation of the washing performance and of the residual protease activity were used:

Determination of the Average Percentage of Stain Removed.

The washing performance (average percentage of stain removed) is determined on polyester/cotton 65/35, using commercial ketchup as standard stain.

About 3±0.001 g of ketchup are deposited on a fabric swatch and sandwiched between a second swatch, over which a 500±0.01 g weight is applied for 15 minutes. The stained swatches are left drying overnight at 20° C. and 65% humidity in a conditioned room.

The swatches are then washed in Linitest Plus (Atlas) at 40° C. for 30 min., each test at 1 g/l active substance with water at 25° F. hardness.

Afterwashing, the swatches are air dried for 15 hours.

Reflectance is evaluated on the Datacolor spectrometer according to the Berger method with a D65/10 light source.

The percentage of stain removed is calculated by the equation:
% of stain removed=[(A-B)/(C-B)]×100

where A is the reflectance after washing, B the reflectance before washing and C the reference reflectance value of the unstained, white swatch (measured before starting each trial).

The average percentage of stain removed is calculated as the average value from three tests.

Evaluation of the Protease Activity

The evaluation of the protease activity (PA) is based on the following principle: the protease hydrolyses azocasein in 20 minutes at 40° C., when the protease is dosed at 1 wt % in an aqueous mixture at pH 8 (0.1M Tris/HCl, 1.25 mM CaCl₂).

The portion of azocasein which has not been hydrolysed is precipitated with trichloroacetic acid, while the hydrolysed azocasein is determined by spectrophotometry in the visible light spectrum.

The protease activity is defined as mg of azocasein hydrolysed per minute and gram of enzymatic preparation.

The initial protease activity (PA₁) is the protease activity measured immediately after the preparation of the composition containing the protease.

The percentage residual protease activity (% RPA) is
%RPA=(APₜ/APᵢ)×100

where APₜ is the protease activity of the composition at the time % RPA is measured.

### EXAMPLE 1

Test of Enzymatic Stability of Aqueous Detergent Compositions of the Invention.

Aqueous based liquid detergent compositions are prepared which contain 0.1 wt % of Purafect® 4000 L (alkaline protease from B subtlis OGM by Gennecor, US) and variable amounts of anionic ester of alkylpolyglycosides (see the first column of Table 1)

Similar compositions (comparative) having the same percentage of Purafect® 4000 L and with variable amounts of traditional anionic surfactants (see the first column of Table 1) are prepared.

The enzymatic stability of the compositions is evaluated by measuring the % RPA one hour after their preparation, using the method above described; from the time of their preparation to the time when the PAₜ is measured the compositions are maintained at 30° C.

The % RPA is Reported in Table 1.

TABLE 1

| | % RPA | | | | | |
|---|---|---|---|---|---|---|
| | Eucarol | Eucarol | | | | |
| | AGE | AGE | Eucarol | Chimpon | Rolpon | Rolpon |
| % a.s.* | EC | ET | AGE SS | BAC** | 24/230** | LS** |
| 0.01 | 100 | 100 | 100 | 85 | 89 | — |
| 0.05 | 100 | 100 | 100 | 26 | 87 | — |
| 1 | 100 | 100 | 100 | 19 | 85 | 0 |
| 5 | 100 | 100 | 100 | 15 | 65 | — |
| 10 | 100 | 100 | 100 | 0 | — | — |

*wt % of active substance of the surfactant in the composition
**comparative compositions

### EXAMPLE 2

Test of Enzymatic Stability of Aqueous Detergent Compositions of the Invention.

Aqueous based detergent compositions are prepared containing 0.15% v of Savinase® 16L (alkaline protease from B. subtilis OGM by Novozymes, DK) and variable amounts of anionic ester of alkylpolyglycosides (see the first column of Table 2)

Similar compositions (comparative) having the same percentage of Savinase® 16L and with variable amounts of traditional anionic surfactants (see the first column of Table 2) are prepared.

The enzymatic stability of the compositions is evaluated by measuring the % RPA one hour after their preparation, using the method above described; from the time of their preparation to the time when the PAₜ is measured the compositions are maintained at 30° C.

The % RPA is Reported in Table 2.

TABLE 2

| | % RPA | | | | | |
|---|---|---|---|---|---|---|
| | Eucarol | Eucarol | | | | |
| | AGE | AGE | Eucarol | Chimpon | Rolpon | Rolpon |
| % a.s.* | EC | ET | AGE SS | BAC** | 24/230** | LS** |
| 0 | 100 | 100 | 100 | 100 | 100 | — |
| 1 | 100 | 100 | 100 | 29 | 68 | — |
| 5 | 100 | 100 | 100 | 26 | 52 | 0 |
| 10 | 100 | 100 | 100 | 25 | — | — |

*wt % of active substance of the surfactant in the composition
**comparative compositions

### EXAMPLE 3

Test of Enzymatic Stability of Aqueous Detergent Compositions of the Invention.

Aqueous based detergent compositions are prepared containing 0.4% v of Purafect® OX 4000L (alkaline protease from B subtilis OGM by Genencor, US) and variable amounts of anionic ester of alkylpolyglycosides (see the first column of Table 3)

Similar compositions (comparative) having the same percentage of Purafect® OX 4000L and with variable amounts of traditional anionic surfactants (see the first column of Table 3) are prepared.

The enzymatic stability of the compositions is evaluated by measuring the % RPA one hour after their preparation, using the method above described; from the time of their preparation to the time when the PAₜ is measured the compositions are maintained at 30° C.

The % RPA is Reported in Table 3.

TABLE 3

| | % RPA | | | | | |
|---|---|---|---|---|---|---|
| | Eucarol | Eucarol | | | | |
| | AGE | AGE | Eucarol | Chimpon | Rolpon | Rolpon |
| % a.s.* | EC | ET | AGE SS | BAC** | 24/230** | LS** |
| 0 | 100 | 100 | 100 | 100 | 100 | — |
| 1 | 100 | 100 | 100 | 19 | 77 | — |
| 5 | 100 | 100 | 100 | 0 | 60 | 0 |
| 10 | 100 | 100 | 100 | 0 | 54 | — |

*wt % of active substance of the surfactant in the composition
**comparative compositions

### EXAMPLE 4

Test of Washing Performance and Enzymatic Stability of Aqueous Detergent Compositions of the Invention.

Aqueous detergent compositions from 1 to 17 are prepared as follows.

25 g of surfactant(s) (see Table 4, where the amount of a.s. of surfactant in grams in each composition is reported) are diluted with 69.5 g of demineralised water, under stirring.

In sequence, under stirring, 0.5 g of protease (Purafect® 4000 L) and 5 g of monopropylene glycol are added.

The mixture is stirred for 15 minutes and the pH is regulated at 7.4-7.6 with citric acid or triethanoleamine.

The washing performance is determined by measuring the average percentage of stain removed, using the above described method.

The average percentage of stain removed (% SR) is reported in Table 4 for each composition.

The enzymatic stability of Compositions 1-17 is evaluated by measuring the % RPA one hour after their preparation, using the method above described; from the time of their preparation to the time when the PAₜ is measured the compositions are maintained at 40° C.

The % RPA of Compositions 1-17 are Reported in Table 4.

TABLE 4

| Comp. | 1 | 2 | 3 | 4 | 5 | % SR | % APR |
|---|---|---|---|---|---|---|---|
| 1* | | | | 25 | | 56.0 | 0 |
| 2* | | | | | 25 | 54.5 | 74 |
| 3* | | | 25 | | | 55.8 | 29 |
| 4 | 25 | | | | | 60.8 | 100 |
| 5 | | 25 | | | | 77.6 | 100 |
| 6* | 5 | | | 20 | | 54.0 | — |
| 7 | 10 | | | 10 | | 55.0 | 36 |
| 8 | 20 | | | 5 | | 56.0 | — |
| 9* | 5 | | | | 20 | 60.1 | — |
| 10 | 10 | | | | 10 | 59.0 | 79 |
| 11 | 20 | | | | 5 | 59.8 | — |
| 12* | | 5 | | 20 | | 56.1 | 0 |
| 13 | | 10 | | 10 | | 65.2 | 56 |
| 14 | | 20 | | 5 | | 75.6 | 65 |
| 15* | | 5 | | | 20 | 62.6 | — |
| 16 | | 10 | | | 10 | 65.9 | 85 |
| 17 | | 20 | | | 5 | 70.6 | 100 |

*comparative compositions
1 = Eucarol ® AGE EC
2 = Eucarol ® AGE SS
3 = Rolpon LS
4 = Chimpon BAC
5 = Rolpon 24/230

1-20. (canceled)

21. An aqueous liquid detergent composition comprising:
a. from 0.1 to 70% by weight (wt %) of one or more anionic surfactants selected from anionic esters of an alkylpolyglycosides having the general formula:
[R—O-(G)ₓ]ₙ-(D)_{y} (I)
wherein:
R is an aliphatic group, saturated or unsaturated, linear or branched, having from 6 to 20 atoms of carbon;
G is a residue of a reducing saccharide connected to R—O by means of an O-glycosidic ether bond;
O is an oxygen atom;
D is an acyl residue of sulfosuccinic acid or of a carboxylic acid selected from the group consisting of citric, tartaric, maleic and malic acid, connected to an oxygen atom of G;
n is a number between 1 and m−1, where m is the number of carboxylic groups in the acid from which D originates;
x is a number from 1 to 10, representing the average degree of oligomerization of G;
y is a number from 1 to 10 representing the degree of average esterification of (G)ₓ;
b. from 0.05 to 10 wt % of an enzyme selected in the group consisting of proteases, amylases, lipases, cellulases and mixture thereof; and
c. from 10 to 95 wt % of water.

22. The aqueous liquid detergent composition according to claim 21 wherein:
R has from 8 to 16 carbons; and
the reducing saccharide is glucose.

23. The aqueous liquid detergent composition according to claim 21, wherein the anionic surfactant is present at a concentration of from 10 to 30 wt %.

24. The aqueous liquid detergent composition according to claim 21, wherein the enzyme is present at a concentration of from 0.10 to 5 wt %.

25. The aqueous liquid detergent composition according to claim 21, wherein the water is present at a concentration of from 20 to 70 wt %.

26. The aqueous liquid detergent composition according to claim 21, further comprising from 0.1 to 50% wt of one or more anionic surfactants having a general formula different from general formula (I), wherein the amount of anionic surfactants having a general formula different from general formula (I) does not exceed the amount of the surfactants having general formula (I).

27. The aqueous liquid detergent composition according to claim 22, further comprising from 0.1 to 500% wt of one or more anionic surfactants having a general formula different from general formula (I), wherein the amount anionic surfactants having a general formula different from general formula (I) does not exceed the amount of the surfactants having general formula (I).

28. The aqueous liquid detergent composition according to claim 22, wherein the anionic surfactant is present at a concentration of from 10 to 30 wt %.

29. The aqueous liquid detergent composition according to claim 22, wherein the enzyme is present at a concentrator of from 0.10 to 5 wt %.

30. The aqueous liquid detergent composition according to claim 22, wherein the water is present at a concentration of from 20 to 70 wt %.

31. The aqueous liquid detergent composition according to claim 26, wherein the one or more anionic surfactants having general formula different from (I) is present at a concentration of from 10 to 30% wt.

32. The aqueous liquid detergent composition according to claim 31, where the one or more anionic surfactants having general formula different from (I) are selected from the group consisting of: linear or branched C₉-C₁₅ alkylsulfates, linear or branched C₉-C₁₅ alkylbenzenesulfonates, and C₈-C₂₄ polyethoxylated alkyl ether sulfates containing from 1 to 20 ethoxyl groups.

33. A procedure for the preparation of the aqueous liquid detergent compositions of claim 1 comprising the steps of:
A. from 0.1 to 70 wt % of one or more anionic surfactants selected from the anionic esters of an alkylpolyglycosides having the general formula:
[R—O-(G)ₓ]ₙ-(D)_{y} (I)
wherein:
R is an aliphatic group, saturated or unsaturated, linear or branched, having from 6 to 20 atoms of carbon;
G is a residue of a reducing saccharide connected to R—O by means of an O-glycosidic ether bond;
O is an oxygen atom;
D is an acyl residue of sulfosuccinic acid or of a carboxylic acid selected from the group consisting of citric, tartaric, maleic and malic acid, connected to an oxygen atom of G;
n is a number between 1 and m−1, where m is the number of carboxylic groups in the acid form which D originates;
x is a number from 1 to 10, representing the average degree of oligomerization of G; and
y is a number from 1 to 10 representing the degree of average esterification of (G)ₓ,
are mixed with from 10 to 95 wt %, preferably from 20 to 70 wt %, of water, under stirring to form a mixture;
B. the mixture is stirred for 10-30 minutes at a temperature of from about 15 to about 30° C., and the pH of the mixture is adjusted to about 4-8; and
C. from 0.05 to 10 wt % of an enzyme selected in the group consisting of proteases, amylases, lipases, cellulases and mixtures thereof is added to the mixture with stirring.

34. The procedure according to claim 33, wherein:
from 10 to 30 wt % of the one or more anionic surfactants is used;
R has from 8 to 16 carbons;
the reducing saccharide is glucose; and
20 to 70 wt % water is used.

35. The procedure according to claim 33, wherein in step A. from 10 to 30 wt % of the mixture of the one or more anionic surfactant having general formula (I) are mixed with from 10 to 95 wt % of water.

36. The procedure according to claim 33, wherein the enzyme is selected from the group consisting of proteases, amylases, lipases, cellulases and mixtures thereof.

37. The procedure according to claim 33, wherein after step A. from 0.1 to 50 wt % of one or more anionic surfactants having a general formula different from general formula (I) are added while stirring to the mixture.

38. The procedure according to claim 37, wherein the anionic surfactants having a general formula different from general formula (I) are added in an amount not exceeding the amount of the surfactant having the general formula (I).

39. Procedure for the preparation of aqueous liquid detergent compositions according to claim 38, wherein from 10 to 30 wt % of the anionic surfactants having the general formula different from (I) are added.

40. The procedure according to claim 39, wherein the anionic surfactants having a general formula different from (I) are chosen from the group consisting of: linear or branched C₉-C₁₅ alkylsulfate, linear or branched C₉-C₁₅ alkylbenzenesulfonates, and C₈-C₂₄ polyethoxylated alkyl ether sulfates containing from 1 to 20 ethoxyl groups.
